(19) United States
(12) Patent Application Publication
(10) Pub. No.: US 2025/0333818 A1
(43) Pub. Date: Oct. 30, 2025

(54) HYDROGEN-RESISTANT MATERIAL AND HYDROGEN-RESISTANT STRUCTURAL COMPONENT

(71) Applicants: KYUSHU UNIVERSITY, NATIONAL UNIVERSITY CORPORATION, Fukuoka-Shi (JP); NGK INSULATORS, LTD., Nagoya-City (JP)

(72) Inventors: Osamu TAKAKUWA, Fukuoka-Shi (JP); Takahiro ISHIKAWA, Toyoake-Shi (JP)

(73) Assignees: KYUSHU UNIVERSITY, NATIONAL UNIVERSITY CORPORATION, Fukuoka-Shi (JP); NGK INSULATORS, LTD., Nagoya-City (JP)

(21) Appl. No.: 19/262,340

(22) Filed: Jul. 8, 2025

Related U.S. Application Data
(63) Continuation of application No. PCT/JP2024/002866, filed on Jan. 30, 2024.

(30) Foreign Application Priority Data
Feb. 1, 2023 (JP) 2023-013816

(51) Int. Cl. C22C 9/06; F04B 15/00; F04D 29/02

(52) U.S. Cl. CPC C22C 9/06; F04D 29/023; F04B 15/00

(57) ABSTRACT

Provided is a hydrogen-resistant material for being processed into a hydrogen-resistant structural part used by being operated in a hydrogen atmosphere. This material is composed of a beryllium copper alloy containing 0.2 to 2.7% by mass of Be, and 0.2 to 2.5% by mass in total of at least one selected from Co, Ni, and Fe, the balance consisting of Cu and unavoidable impurities, a total content of Cu, Be, Co, Ni, and Fe being 99.0% by mass of more of the beryllium copper alloy. This hydrogen-resistant material exhibits a tensile strength of 700 MPa or more and exhibits a relative reduction of area (RRA) of 0.80 or more according to a slow strain rate tensile test, in each of an air atmosphere and a hydrogen atmosphere, and exhibits a fracture toughness value K_{IC} of 50 MPa·m^{1/2} or more, in each of an air atmosphere and a hydrogen atmosphere.

### CROSS-REFERENCE TO RELATED APPLICATIONS

This application is a continuation application of PCT/JP2024/002866 filed Jan. 30, 2024, which claims priority to Japanese Patent Application No. 2023-013816 filed Feb. 1, 2023, the entire contents all of which are incorporated herein by reference.

### BACKGROUND OF THE INVENTION

### 1. Field of the Invention

The present invention relates to a hydrogen-resistant material and a hydrogen-resistant structural part.

### 2. Description of the Related Art

In recent years, demand for hydrogen as a fuel used in fuel cell vehicles, power plants, and the like has rapidly increased. Hydrogen as a fuel comes into direct contact with containers and members of equipment in the process of each of production, transportation, storage, and use; however, because many metal materials undergo hydrogen embrittlement, consideration must be given to their use. In particular, because parts that operate under hydrogen require high strength and toughness, it is highly required to give consideration to their hydrogen embrittlement resistance.

Examples of parts that operate under hydrogen include parts of hydrogen compressors, such as pistons and cylinders of reciprocating compressors, rotors and casings of rotary compressors, impellers of axial compressors, and impellers and shafts of centrifugal compressors. At present, chromium molybdenum steels such as SCM431 and SCM435 are often used for these structural members, in particular for operating parts; however, in reality, these parts are operated only in the low-load stress range in consideration of hydrogen brittleness.

Higher performance is required in hydrogen compressors, in order to deal with the rapid increase in demand for hydrogen. For example: 1) Higher-speed rotation of a shaft and an impeller requires higher performance, reduction in the number of connected hydrogen compressors, and reduction in impellers; 2) the shaft and impeller are required to maintain high rigidity, in order to prevent vibration during high-speed rotation; and (3) intermittent operation such as DSS (Daily Start & Stop) is required for green hydrogen production applications, because of the use of sunlight and wind power, which are not stable in energy supplies. However, because structural materials made of chromium molybdenum steels have hydrogen brittleness, they are insufficient in terms of carrying out higher-speed rotation and intermittent operation.

On the other hand, it is known that beryllium copper alloys can exhibit hydrogen resistance. For example, Patent Literature 1 (JP6755521B) discloses a hydrogen-resistant member to be used in contact with hydrogen, and discloses that this heat exchange member is composed of a beryllium copper alloy in which a Be content is 0.20% by mass or more and 2.70% by mass or less, a total content of Co, Ni, and Fe is 0.20 to 2.50% by mass, and a total content of Cu, Be, Co, Ni, and Fe is 99% by mass or more. Patent Literature 2 (JP2021-115631A) discloses a method for producing a hydrogen-resistant member having good hydrogen embrittlement resistance, and discloses a method in which surfaces of first and second beryllium copper alloy members are soaked in an alkaline solution; the surfaces of the copper alloy members are boiled in a solution of an organic acid such as formic acid; and the first and second copper alloy members are bonded by heating and pressurization. Patent Literature 3 (WO2022/149561) discloses a copper alloy bonded body composed of a plurality of members made of an age-hardenable copper alloy, the members diffusion-bonded to one another, wherein the copper alloy bonded body has undergone solution annealing and aging treatment. It is described that this copper alloy bonded body, including the bonded part, has excellent hydrogen embrittlement resistance as well as high tensile strength. Specifically, Patent Literature 3 discloses a copper alloy bonded body having a tensile strength of 520 MPa or more and an RRA (Relative Reduction of Area) of 0.8 or more in a hydrogen gas, in a slow strain rate tensile (SSRT) test performed at a strain rate in the range of 5×10⁻⁵ s⁻¹ or less (for example, 5×10⁻⁵ s⁻¹).

### CITATION LIST

### Patent Literature

Patent Literature 1: JP6755521B
Patent Literature 2: JP2021-115631A
Patent Literature 3: WO2022/149561

### Non-Patent Literature

Non-Patent Literature 1: Hisao Matsunaga, Junichiro Yamabe, and Saburo Matsuoka, “Proposal of Design Method Enabling Cr-Mo Steels to be Used in High-Pressure Hydrogen Gas Environment”, Journal of the Surface Science Society of Japan Vol. 36, No. 11, pp. 562-567, 2015
Non-Patent Literature 2: Saburo Matsuoka, Hisao Matsunaga, Junichiro Yamabe, Shigeru Hamada, and Takashi lijima, “Various strength properties of SCM435 and SNCM439 low-alloy steels in 115 MPa hydrogen gas and proposal of design guideline”, Transactions of the JSME, Vol. 83, No. 854, pp. 1-20, 2017 [DOI: 10.1299/transjsme.17-00264]

### SUMMARY OF THE INVENTION

As described above, because structural materials made of chromium molybdenum steels have hydrogen brittleness, they are insufficient in terms of operation under a high-load stress in a hydrogen atmosphere, in particular intermittent operation and higher-speed rotation. For example, the currently used SCM435 exhibits excellent fracture toughness in air, but have been confirmed to undergo hydrogen deterioration, and thus, is not suitable for intermittent operation that causes fatigue. Therefore, beryllium copper alloys, which are less likely to deteriorate in a hydrogen atmosphere, are promising candidates as an alternative material to chromium molybdenum steels. However, the material strength and fracture toughness required for a rotary structure such as a shaft or impeller are in a trade-off relationship. Therefore, there is a desire for a hydrogen-resistant material that achieves both material strength and fracture toughness required for a structural member that operates in a hydrogen atmosphere, and in which these properties are less likely to be reduced in a hydrogen atmosphere (i.e., excellent in hydrogen embrittlement resistance).

The present inventors have now found that, by subjecting a beryllium copper alloy having a predetermined composition to overaging treatment, it is possible to provide a hydrogen-resistant material that achieves both material strength and fracture toughness required for a structural member that operates in a hydrogen atmosphere, and in which these properties are not reduced or are less likely to be reduced in a hydrogen atmosphere (i.e., excellent in hydrogen embrittlement resistance).

Accordingly, it is an object of the present invention to provide a hydrogen-resistant material that achieves both material strength and fracture toughness required for a structural part that operates in a hydrogen atmosphere, and in which these properties are not reduced or are less likely to be reduced in a hydrogen atmosphere (i.e., excellent in hydrogen embrittlement resistance).

The present invention provides the following aspects.

### Aspect 1

A hydrogen-resistant material for being processed into a hydrogen-resistant structural part used by being operated in a hydrogen atmosphere, the hydrogen-resistant material being composed of a beryllium copper alloy comprising:
0.20 to 2.70% by mass of Be;
0.20 to 2.50% by mass in total of at least one selected from the group consisting of Co, Ni, and Fe;
the balance consisting of Cu and unavoidable impurities, wherein a total content of Cu, Be, Co, Ni, and Fe is 99.0% by mass of more of the beryllium copper alloy,
wherein the hydrogen-resistant material exhibits a tensile strength of 700 MPa or more, according to a slow strain rate tensile test performed at a strain rate of 5×10⁻⁵ s⁻¹ or less, in each of an air atmosphere and a hydrogen atmosphere at 115 MPa,
wherein the hydrogen-resistant material exhibits a relative reduction of area (RRA) of 0.80 or more, as determined by the slow strain rate tensile test, and
wherein the hydrogen-resistant material exhibits a fracture toughness value K_{IC} of 50 MPa·m^{1/2} or more, in each of an air atmosphere and a hydrogen atmosphere at 115 MPa.

### Aspect 2

The hydrogen-resistant material according to aspect 1,
wherein in the beryllium copper alloy,
a Be content is 1.60 to 2.70% by mass,
a total content of Co and Ni is 0.20% by mass or more,
a total content of Cu, Ni, and Fe is 0.60% by mass or less, and
a total content of Cu, Be, Co, Ni and Fe is 99.5% by mass or more.

### Aspect 3

The hydrogen-resistant material according to aspect 1 or 2, wherein the hydrogen-resistant material exhibits a Charpy impact value of 21 J/cm² or more, as measured by a V-notch Charpy impact test in an air atmosphere.

### Aspect 4

The hydrogen-resistant material according to aspect 3, wherein the Charpy impact value is 30 J/cm² or more.

### Aspect 5

The hydrogen-resistant material according to any one of aspects 1 to 4, wherein the hydrogen-resistant material exhibits a 0.2% yield strength of 520 MPa or more, in each of an air atmosphere and a hydrogen atmosphere at 115 MPa.

### Aspect 6

A hydrogen-resistant structural part produced using the hydrogen-resistant material according to any one of aspects 1 to 5.

### Aspect 7

The hydrogen-resistant structural part according to aspect 6, wherein the hydrogen-resistant structural part is at least one selected from the group consisting of a container (for example, a container for storing high-pressure hydrogen), a pipe, a valve, and a joint, which are brought into direct contact with high-pressure hydrogen, and a constituent member of a hydrogen compressor.

### Aspect 8

The hydrogen-resistant structural part according to aspect 7, wherein the hydrogen-resistant structural part is the constituent member of the hydrogen compressor, and the constituent member of the hydrogen compressor is at least one selected from the group consisting of a piston and a cylinder of a reciprocating compressor, a rotor and a casing of a rotary compressor, an impeller of an axial compressor, and an impeller and a shaft of a centrifugal compressor.

### DETAILED DESCRIPTION OF THE INVENTION

### Hydrogen-Resistant Material

The hydrogen-resistant material according to the present invention is a material for being processed into a hydrogen-resistant structural part used (in particular, used by being operated) in a hydrogen atmosphere. Preferred examples of the hydrogen-resistant structural part used in a hydrogen atmosphere include containers (for example, containers for storing high-pressure hydrogen), pipes, valves, and joints, which are brought into direct contact with high-pressure hydrogen. Furthermore, preferred examples of the hydrogen-resistant structural part used by being operated in a hydrogen atmosphere include, but are not limited to, various constituent members of hydrogen compressors (for example, pistons and cylinders of reciprocating compressors, rotors and casings of rotary compressors, impellers of axial compressors, and, in particular, impellers and shafts of centrifugal compressors). The hydrogen-resistant material is composed of a beryllium copper alloy. This beryllium copper alloy comprises 0.20 to 2.70% by mass of Be, and 0.20 to 2.50% by mass in total of at least one selected from the group consisting of Co, Ni, and Fe, the balance consisting of Cu and unavoidable impurities, a total content of Cu, Be, Co, Ni, and Fe being 99.0% by mass of more of the beryllium copper alloy. Furthermore, this hydrogen-resistant material (i) exhibits a tensile strength of 700 MPa or more, according to a slow strain rate tensile test performed at a strain rate of 5×10⁻⁵ s⁻¹ or less, in each of an air atmosphere and a hydrogen atmosphere at 115 MPa; (ii) exhibits a relative reduction of area (RRA) of 0.80 or more, as determined by the slow strain rate tensile test; and (iii) exhibits a fracture toughness value K_{IC} of 50 MPa·m^{1/2} or more, in each of an air atmosphere and a hydrogen atmosphere at 115 MPa. These properties are achieved by subjecting the beryllium copper alloy having the above-mentioned composition to overaging treatment. Specifically, the strength of an age-hardenable beryllium copper alloy increases as aging treatment of the beryllium copper alloy proceeds; however, when the aging treatment is continued even after the peak strength has passed so that the beryllium copper alloy is brought to an overaged state, the strength is reduced to some extent, but the Charpy impact value and fracture toughness value K_{IC} are significantly improved. It has been confirmed that in other materials such as chromium molybdenum steels, these properties are significantly reduced under hydrogen. In contrast, using the beryllium copper alloy of the above-mentioned composition for which the present inventors have confirmed through testing that these properties are not reduced even in a hydrogen atmosphere, it is possible to provide a hydrogen-resistant material that achieves both material strength and fracture toughness required for a structural part that operates in a hydrogen atmosphere, and in which these properties are not reduced or are less likely to be reduced in a hydrogen atmosphere (i.e., excellent in hydrogen embrittlement resistance).

Specifically, as described above, because structural materials made of chromium molybdenum steels have hydrogen brittleness, when they are used under hydrogen, in particular under conditions where they are subjected to stress loading and unloading, the structural materials are insufficient in that the influence of reduction in strength and toughness upon the member reliability is significant. Therefore, beryllium copper alloy aged materials that have been confirmed not to deteriorate in a hydrogen atmosphere in Patent Literature 1 (JP6755521B) and the like are promising candidates as an alternative material to chromium molybdenum steels. However, the material strength (for example, tensile strength) and fracture toughness (for example, fracture toughness value K_{IC}) required for a rotary structure such as a shaft or impeller are in a trade-off relationship. Therefore, it has so far been difficult to realize a hydrogen-resistant material that achieves both material strength and fracture toughness required for a structural part that operates in a hydrogen atmosphere, and in which these properties are less likely to be reduced in a hydrogen atmosphere (i.e., excellent in hydrogen embrittlement resistance). In this respect, the present invention advantageously overcomes this problem.

The beryllium copper alloy constituting the hydrogen-resistant material of the present invention comprises 0.20 to 2.70% by mass of Be, and 0.20 to 2.50% by mass in total of at least one selected from the group consisting of Co, Ni, and Fe, the balance consisting of Cu and unavoidable impurities, a total content of Cu, Be, Co, Ni, and Fe being 99.0% by mass of more of the beryllium copper alloy. Preferred example of beryllium alloys that meet this composition include beryllium copper alloy 25 (hereinafter referred to as CuBe25), beryllium copper alloy 165 (hereinafter referred to as CuBe165), and beryllium copper alloy 11 (hereinafter referred to as CuBe11). The compositions of these alloys are as shown below.

### Table 1

TABLE 1
Compositions (% by mass) of various beryllium copper alloys

| Alloy | | | | Co + | | JIS alloy |
|---|---|---|---|---|---|---|
| type | Be | Ni | Co + Ni | Ni + Fe | Balance | number |
| CuBe25 | 1.80-2.00 | — | 0.20 or | 0.60 or | Cu | C1720 |
| | | | more | less | | |
| CuBe165 | 1.60-1.79 | — | 0.20 or | 0.60 or | Cu | C1700 |
| | | | more | less | | |
| CuBe11 | 0.20-0.60 | 1.40-2.20 | — | — | Cu | C1751 |

Be provides the copper alloy with excellent basic performance (strength, processability, fatigue properties, heat resistance, corrosion resistance, hydrogen embrittlement resistance, and the like) as a beryllium copper alloy. The Be content in the beryllium copper alloy constituting the hydrogen-resistant material is 0.20 to 2.70% by mass, preferably 0.20 to 2.20% by mass, more preferably 1.60 to 2.00% by mass, and still more preferably 1.80 to 2.00% by mass. When the Be content is in the above-mentioned range, the above-mentioned basic performance can be effectively achieved, and the influence of the inclusion of an excessive amount of Be upon the price can be avoided.

In beryllium copper alloys, Co, Ni and/or Fe contributes mainly to preventing early overprecipitation of the grain boundary y phase in high strength-type C1720 and C1700 shown in Table 1, and contributes mainly to improving mechanical properties through precipitation as beryllide in high electrical conductivity-type C1751 shown in Table 1. The total content of at least one selected from the group consisting of Co, Ni, and Fe in the beryllium copper alloy constituting the hydrogen-resistant material is 0.20 to 2.50% by mass, preferably 0.20 to 2.20% by mass, and more preferably 0.20 to 0.60% by mass. Of Co, Ni, and Fe, Co is a particularly preferred element, from the viewpoint of the effect of preventing early overprecipitation of the grain boundary y phase.

The total content of Cu, Be, Co, Ni, and Fe in the beryllium copper alloy constituting the hydrogen-resistant material is 99.0% by mass or more, and preferably 99.5% by mass or more, of the beryllium copper alloy. Therefore, the beryllium copper alloy is substantially free of components other than Cu, Be, Co, Ni, and Fe. Thus, it can be said that the balance other than Be, Co, Ni, and Fe in the beryllium copper alloy is composed of Cu and unavoidable impurities.

In a particularly preferred beryllium copper alloy, the Be content is 1.60 to 2.00% by mass, the total content of Co and Ni is 0.20% by mass or more, the total content of Cu, Ni, and Fe is 0.60% by mass or less, and the total content of Cu, Be, Co, Ni, and Fe is 99.5% by mass or more. Examples of alloys that meet this composition include CuBe25 and CuBe165.

The hydrogen-resistant material of the present invention exhibits a tensile strength of 700 MPa or more, according to a slow strain rate tensile test (SSRT) performed at a strain rate of 5×10⁻⁵ s⁻¹ or less (for example, 5×10⁻⁵ s⁻¹), in each of an air atmosphere and a hydrogen atmosphere at 115 MPa, with the tensile strength being preferably 780 MPa or more, more preferably 850 MPa or more. This hydrogen-resistant material has a high tensile strength not only in an air atmosphere but also in a hydrogen atmosphere. The above-mentioned tensile strength is desirably higher (as long as the desired fracture toughness value K_{IC} is obtained), and thus, the upper limit should not be specified, but is typically 1100 MPa or less, and more typically 1000 MPa or less. This slow strain rate tensile test may be performed by preparing a specimen in accordance with ASTM E8M Specimen 4, and following the procedure described in the examples below in accordance with ASTM-G-142. Commonly, the slow strain rate tensile test evaluates the hydrogen susceptibility using the relative reduction of area (RRA), which is obtained by dividing the tensile strength or reduction of area in a hydrogen gas by the tensile strength or reduction of area in a reference gas that is free of influence of hydrogen. In the slow strain rate tensile test, measurement may be performed at a strain rate of 5×10⁻⁵ s⁻¹. Assuming that the member is used under hydrogen, this slow strain rate tensile test is performed at a hydrogen gas pressure of 115 MPa. The higher the hydrogen gas pressure, the greater the amount of hydrogen that penetrates into the material, and thus, the specimen is more likely to be affected by hydrogen exposure, so that the hydrogen brittleness can be evaluated more properly. In the test concerning the present application, the hydrogen properties are evaluated by calculating the relative reduction of area (RRA) following the procedure described in the examples below.

Thus, the hydrogen-resistant material of the present invention evaluated by the above-mentioned slow strain rate tensile test exhibits a relative reduction of area (RRA) of 0.80 or more, and preferably 0.90 or more. While the upper limit of RRA is theoretically 1, it may exceed 1.0 due to errors or fluctuations in the actually measured values; thus, it is typically 1.10 or less, and more typically 1.05 or less. The fact that the tensile strength of the hydrogen-resistant material is a value within the above-mentioned range in room-temperature air or under a hydrogen gas pressure of 115 MPa and that the RRA is also a value within the above-mentioned range means that the hydrogen-resistant material has a strength suitable for a hydrogen-resistant structural part (in particular, a rotary structure such as a shaft or impeller), which is less likely to be reduced in a hydrogen atmosphere (i.e., hydrogen embrittlement is less likely to occur). Therefore, the hydrogen-resistant material of the present invention can be said to have excellent hydrogen embrittlement resistance, from the viewpoint of tensile strength.

Moreover, the hydrogen-resistant material of the present invention exhibits a fracture toughness value K_{IC} of 50 MPa·m^{1/2} or more, preferably 60 MPa·m^{1/2} or more, and more preferably 65 MPa·m^{1/2} or more, in each of an air atmosphere and a hydrogen atmosphere at 115 MPa. This hydrogen-resistant material has a high fracture toughness value K_{IC} not only in an air atmosphere but also in a hydrogen atmosphere. The fracture toughness value K_{IC} is desirably higher (as long as the desired tensile strength is obtained), and thus, the upper limit should not be specified, but is typically 200 MPa·m^{1/2} or less, and more typically 150 MPa·m^{1/2} or less. The fracture toughness value K_{IC} may be measured by performing a K_{IC} test, which is a static fracture toughness test, in accordance with ASTM E-399-90, following the procedure described in the examples below. As described above, the tensile strength and fracture toughness value K_{IC} required for a rotary structure such as a shaft or impeller are in a trade-off relationship; however, the hydrogen-resistant material of the present invention exhibits a good fracture toughness value K_{IC} while having a tensile strength acceptable for a hydrogen-resistant structural part (in particular, a rotary structure such as a shaft or impeller), not only in an air atmosphere but also in a hydrogen atmosphere. That is, the good fracture toughness value K_{IC} is not reduced or less likely to be reduced in a hydrogen atmosphere (i.e., hydrogen embrittlement is less likely to occur). Therefore, the hydrogen-resistant material of the present invention can be said to have excellent hydrogen embrittlement resistance, not only from the viewpoint of the tensile strength described above, but also fracture toughness.

The hydrogen-resistant material of the present invention exhibits a Charpy impact value of 21 J/cm² or more, and more preferably 30 J/cm² or more, as measured by a V-notch Charpy impact test in an air atmosphere. Although the Charpy impact value cannot be measured in a hydrogen atmosphere, it is correlated to the fracture toughness value K_{IC}, and has the advantage of being measured inexpensively. This high Charpy impact value means high fracture toughness of the hydrogen-resistant material, which improves the reliability as a hydrogen-resistant structural part (in particular, a rotary structure such as a shaft or impeller). Therefore, the upper limit of the Charpy impact value should not be specified, but is typically 120 J/cm² or less, and more typically 100 J/cm² or less, considering the balance with the material strength. The V-notch Charpy impact test may be performed following the procedure described in the examples below in accordance with JIS Z 2242:2018.

The hydrogen-resistant material of the present invention preferably exhibits a 0.2% yield strength of 520 MPa or more, and more preferably 700 MPa or more, in each of an air atmosphere and a hydrogen atmosphere at 115 MPa. Having this high 0.2% yield strength in both the air atmosphere and hydrogen atmosphere means that the hydrogen-resistant material has high reliability, which is not reduced or less likely to be reduced in the hydrogen atmosphere (i.e., hydrogen embrittlement is less likely to occur). Therefore, the upper limit of the 0.2% yield strength should not be specified, but is typically 1000 MPa or less, and more typically 900 MPa or less, considering the balance with the material strength. The 0.2% yield strength may be measured by cutting a specimen from the hydrogen-resistant material in accordance with the ASTM E8M standard, and performing a tensile test in air or a hydrogen atmosphere, following the procedure described in the examples below.

### Production Method

The hydrogen-resistant material according to the present invention can be favorably produced by preparing a beryllium copper alloy having the composition described above by a known production method (see, for example, Patent Literature 1) and subjecting it to overaging treatment. For example, the hydrogen-resistant member can be prepared by (1) a melt-casting step; (2) a homogenization treatment step; (3) a hot forging step, a hot rolling step and/or a hot extrusion step; (4) a solution annealing step; (5) a cold working step; and (6) an overaging treatment step. Specifically, each step is as follows.
(1) Melt-Casting Step

In this step, it is common as an industrial method that raw materials are mixed and then melted in a high-frequency furnace, and an ingot is produced by semi-continuous casting. Other methods such as melting in an EREMA furnace, a die casting method, and a low-pressure casting method can also be employed, and the casting method is not specifically limited. The mold used for casting can be made of pure copper, a copper alloy, or alloy steel. The melt atmosphere may be air, or may be an inert atmosphere such as nitrogen, argon, or helium, as required. In the melt-casting step, the content of various impurities (for example, S and P) is preferably restricted to less than 0.01% by mass.
(2) Homogenization Treatment Step

This step is intended to homogenize the inhomogeneous structure of the ingot by keeping it at a high temperature. The homogenization treatment conditions vary depending on the composition. For example, C1720 and C1700 shown in Table 1 above can be effectively treated by keeping at a temperature in the range of 750 to 850° C. for 4 hours or more and less than 24 hours, while C1751 can be effectively treated by keeping at a temperature of 900 to 1000° C. for 4 hours or more and less than 24 hours. Here, if the treatment time at each temperature for each alloy is less than 4 hours, the diffusion of atoms such as Be cannot be sufficiently promoted. Furthermore, if the treatment is longer than 24 hours, a certain homogenization effect has been completed, and no further effect can be expected.
(3) Hot Forging Step, Hot Rolling Step and/or Hot Extrusion Step

These steps are intended to destroy the cast structure of the ingot after the homogenization treatment to cause recrystallization, so as to improve mechanical properties such as material strength and elongation after the subsequent steps of annealing treatment, solution annealing, and aging treatment (including overaging treatment), or are intended to process the ingot into a desired shape simultaneously. Here, an integrated forging ratio and a processing ratio significantly affect the degree of destruction of the cast structure. A hot-forged material is commonly obtained by repeating upsetting and stretching a plurality of times. For example, with respect to a forging ratio that is expressed as 3 S in stretching the material 3 times its length, or expressed as 1/2 U in upsetting the material to its ½ length, the integrated forging ratio is expressed by integrating the values in stretching and the inverses of the values in upsetting. The higher the integrated forging ratio, the greater the destruction of the cast structure, resulting in a fine and preferred forged structure. In hot rolling or hot extrusion, the processing ratio is the difference between the cross-sectional area of the ingot and the cross-sectional area of the rolled material or extruded material after being processed. In hot rolling or hot extrusion, the higher the processing ratio, the greater the destruction of the cast structure, resulting in a fine and preferred forged structure. However, there are restrictions on the processing ratio because of the final product shape; thus, in order to obtain a finer structure, the ingot may be subjected to hot forging first to destroy the cast structure, and then hot rolling or hot extrusion may be performed again. Furthermore, the hot-working temperature rate in hot forging, hot rolling, and hot extrusion may be controlled to perform grain size control in the subsequent step of solution annealing. Alternatively, a similar effect can be achieved by performing, after these steps, heat treatment at a temperature equal to or less than the solution annealing temperature.

### (4) Solution Annealing

In this step, the hot-forged ingot, hot-rolled material or hot-extruded material is subjected to solution annealing to obtain a solution-annealed material containing additives such as Be and Co in solid solution in the Cu matrix. Specifically, the hot-forged ingot, hot-rolled material or hot-extruded material are heated and kept over a predetermined solution annealing temperature in a predetermined solution annealing temperature range and then water-cooled to obtain the solution-annealed material. With respect to the solution annealing temperature range, C1720 or C1700 can be effectively treated by keeping at a temperature of 720 to 850° C. for substantially 30 minutes or more, while C1751 can be effectively treated by keeping at 900 to 1000° C. for substantially 30 minutes or more. In both cases, it is industrially common that the material is kept in a furnace that has reached the above-mentioned set temperature for about 2 to 5 hours, and then water-cooled.

### (5) Cold Working

In this step, the solution-annealed material is subjected to cold working to obtain a solution-annealed cold-worked material. Specifically, cold forging is common for a solution-annealed material of a forged material; cold rolling is common for a solution-annealed material of a rolled material; and cold drawing is common for a solution-annealed material of an extruded material. Performing cold working increases the density of dislocations after solution annealing to increase nuclei as starting points of age precipitation. This can be expected to increase the strength at peak aging, and additionally improve the balance between strength and toughness at overaging.

### (6) Overaging Treatment

In this step, the solution-annealed cold-worked material is kept at a predetermined age-hardening treatment temperature for a predetermined time so that a precipitation phase is precipitated to obtain an aged material. Here, the precipitation phase in the beryllium copper changes as follows: (A) GP zone→(b) γ″ phase (crystal structure: BCT (body-centered tetragonal))→(c) γ₁′ phase (crystal structure: BCM (body-centered monoclinic))→(d) γ₁ phase (crystal structure: BCT (body-centered tetragonal))→(e) γ′ phase (crystal structure: BCT (body-centered tetragonal))→(f) γ phase (crystal structure: BCC (body-centered cubic)). The treatment temperature as a peak aging condition to obtain high strength and hardness is 250 to 340° C. for C1720 or C1700 and 430 to 500° C. for C1751. The aging treatment time at these treatment temperatures is preferably 15 minutes to 24 hours or less. Most of the phases precipitated at this peak aging are constituted by substantially only the (c)γ₁′ phase, after the (a) GP zone and the (b)γ″ phase, and the tensile strength and hardness reach a maximum in this precipitation phase, whereas the toughness is insufficient. However, when overaging treatment at a higher temperature is performed, the phase changes as follows: (d) γ₁ phase→(e) γ′ phase→(e) γ phase, and the strength and hardness are reduced, whereas toughness is improved. The present inventors have previously confirmed that hydrogen embrittlement does not occur in the beryllium copper at peak aging (see Patent Literature 1); however, hydrogen properties in the (d) γ₁ phase, (e) γ′ phase, and (f) γ phase formed by overaging were not confirmed at that time, and these properties have been newly found by the present inventors.

### Hydrogen-Resistant Structural Part

The hydrogen-resistant material of the present invention achieves both material strength and fracture toughness required for a structural member used in a hydrogen atmosphere, in particular a structural member that operates in a hydrogen atmosphere, and these properties are not reduced or are less likely to be reduced in a hydrogen atmosphere (i.e., excellent in hydrogen embrittlement resistance). Therefore, the hydrogen-resistant material of the present invention is suitable for being processed into a hydrogen-resistant structural part used (in particular, used by being operated) in a hydrogen atmosphere, and is particularly suitable for a hydrogen-resistant structural part used in intermittent operation or high-speed rotation that tends to cause fatigue in a hydrogen atmosphere. Preferred examples of such hydrogen-resistant structural parts include, but are not limited to, containers (for example, containers for storing high-pressure hydrogen), pipes, valves, and joints, which are brought into direct contact with high-pressure hydrogen, and additionally various constituent members of hydrogen compressors (for example, pistons and cylinders of reciprocating compressors, rotors and casings of rotary compressors, impellers of axial compressors, and, in particular, impellers and shafts of centrifugal compressors).

### EXAMPLES

The present invention will be described in more detail with reference to the following examples.

### Examples 1a and 1b (Comparative)

### (1) Preparation of Hydrogen-Resistant Materials

Raw materials were weighed to give the alloy composition of CuBe25 (JIS C1720) shown in Table 2, melted and cast to produce an ingot of the CuBe25 alloy. This ingot was subjected to soaking (homogenization annealing) at 780° C. for 8 hours and then to hot forging at an integrated forging ratio of 18 to obtain a forged ingot. This forged ingot was water-cooled from 780° C. to be solution-annealed, and then subjected to 40% cold working to obtain a solution-annealed cold-worked material. The resulting solution-annealed cold-worked material was subjected to aging treatment at 315° C. for 3 hours to prepare a hydrogen-resistant material as a peak-aged material.

It should be noted that the forging ratio is expressed as 3S in stretching the material 3 times its length, or expressed as 1/2 U in upsetting the material to its ½ length. The above-mentioned integrated forging ratio was calculated by integrating the values in stretching and the inverses of the values in upsetting.

### (2) Evaluation of Hydrogen-Resistant Materials

The hydrogen-resistant materials prepared were subjected to various evaluations as follows. The results were as shown in Table 3.

### <Slow Strain Rate Tensile Test (SSRT)>

The hydrogen-resistant material was cut into a specimen in accordance with ASTM E8M Specimen 4. The slow strain rate tensile test was performed in air or a 115 MPa hydrogen atmosphere at room temperature, at a displacement rate of 0.001 mm/sec (strain rate: 0.00005/sec), in accordance with ASTM-G-142. In this manner, the slow strain rate tensile strength was measured in each atmosphere. Furthermore, a cross-sectional reduction of area RA of the specimen obtained in the slow strain rate tensile test in each atmosphere was calculated according to the following equation:

$$RA = ( {A}_{0} - {A}_{1} ) / {A}_{0}$$

wherein A₀ is the cross-sectional area of the specimen before the slow strain rate tensile test, and A₁ is the cross-sectional area of the portion broken by necking after the slow strain rate tensile test. The RRA (relative reduction of area) as an index for evaluating the hydrogen embrittlement properties was calculated by dividing a cross-sectional reduction of area RA_{H2} in a 115 MPa hydrogen atmosphere by a cross-sectional reduction of area RA_{Air} in an air atmosphere (i.e., by determining the ratio RA_{H2}/RA_{Air}).

### <Vickers Hardness>

A Vickers hardness test in accordance with JIS Z 2244:2009 was performed to measure the Vickers hardness of each hydrogen-resistant material. A test force of 4.9 N (hardness symbol HV 0.5) was selected.

### <Charpy Impact Test>

A Charpy impact test in accordance with JIS Z 2242:2018 was performed to measure the Charpy impact value of each hydrogen-resistant material. This Charpy impact test was performed by processing the hydrogen-resistant material to prepare a V-notch specimen as specified in JIS Z 2242:2018 (55 mm in length, a shape with a square cross section of 10 mm on one side, a V-notch at the center of the length, a notch angle of 45°, a notch depth of 2 mm, and a notch bottom radius of 0.25 mm), and then by measuring the Charpy impact value (absorbed energy) in an air atmosphere at room temperature, using a Charpy impact tester (automatic charpy impact tester CI-500D, manufactured by Tokyo Koki Testing Machine Co., Ltd.).

### <Fracture Toughness Test>

Each hydrogen-resistant material was subjected to a K_{IC} test, which is a static fracture toughness test, in accordance with ASTM E-399-90, in an air atmosphere or a 115 MPa hydrogen atmosphere at room temperature, to measure the fracture toughness value K_{IC} of the hydrogen-resistant material.

### <0.2% Yield Strength>

For each hydrogen-resistant material, 0.2% yield strength was measured based on a stress-strain diagram obtained in the above-described slow strain rate tensile test performed for the hydrogen-resistant material in an air atmosphere or a 115 MPa hydrogen atmosphere at room temperature. Specifically, in the stress-strain diagram obtained in the tensile test in an air atmosphere or a 115 MPa hydrogen atmosphere, a slope at arbitrary points decided to be elastic (modulus of elasticity) was determined, and a straight line was drawn along the slope; the straight line determined was offset to 0.2% strain; and the value at the intersection of the offset straight line and the stress-strain relationship was defined as the 0.2% yield strength.

### Example 2 (Comparative)

Preparation and various evaluations of the material were performed as in Examples 1a and 1b, except that the solution-annealed cold-worked material was subjected to aging treatment at 340° C. for 6 hours to obtain an overaged material. The results were as shown in Table 3.

### Example 3

Preparation and various evaluations of the material were performed as in Examples 1a and 1b, except that the solution-annealed cold-worked material was subjected to aging treatment at 390° C. for 3 hours to obtain an overaged material. The results were as shown in Table 3.

### Example 4

Preparation and various evaluations of the material were performed as in Examples 1a and 1b, except that the solution-annealed cold-worked material was subjected to aging treatment at 390° C. for 6 hours to obtain an overaged material. The results were as shown in Table 3.

### Example 5

Preparation and various evaluations of the material were performed as in Examples 1a and 1b, except that the solution-annealed cold-worked material was subjected to aging treatment at 390° C. for 9 hours to obtain an overaged material. The results were as shown in Table 3.

### Example 6

Preparation and various evaluations of the material were performed as in Examples 1a and 1b, except that the solution-annealed cold-worked material was subjected to aging treatment at 430° C. for 3 hours to obtain an overaged material. The results were as shown in Table 3.

### Example 7

Preparation and various evaluations of the material were performed as in Examples 1a and 1b, except that the solution-annealed cold-worked material was subjected to aging treatment at 410° C. for 18 hours to obtain an overaged material. The results were as shown in Table 3.

### Example 8 (Comparative)

Raw materials that give the alloy composition of CuBe165 (JIS C1700) shown in Table 2 were used and subjected to the same process as in Examples 1a and 1b to obtain a solution-annealed cold-worked material. The solution-annealed cold-worked material was then subjected to aging treatment at 315° C. for 3 hours to obtain a peak-aged material. The material thus obtained was subjected to various evaluations as in Examples 1a and 1b. The results were as shown in Table 3.

### Example 9

Raw materials that give the alloy composition of CuBe165 (JIS C1700) shown in Table 2 were used and subjected to the same process as in Examples 1a and 1b to obtain a solution-annealed cold-worked material. The solution-annealed cold-worked material was then subjected to aging treatment at 370° C. for 21 hours to obtain an overaged material. The material thus obtained was subjected to various evaluations as in Examples 1a and 1b. The results were as shown in Table 3.

### Example 10

Raw materials that give the alloy composition of CuBe165 (JIS C1700) shown in Table 2 were used and subjected to the same process as in Examples 1a and 1b to obtain a solution-annealed cold-worked material. The solution-annealed cold-worked material was then subjected to aging treatment at 370° C. for 27 hours to obtain an overaged material. The material thus obtained was subjected to various evaluations as in Examples 1a and 1b. The results were as shown in Table 3.

### Example 11

Raw materials that give the alloy composition of CuBe165 (JIS C1700) shown in Table 2 were used and subjected to the same process as in Examples 1a and 1b to obtain a solution-annealed cold-worked material. The solution-annealed cold-worked material was then subjected to aging treatment at 390° C. for 9 hours to obtain an overaged material. The material thus obtained was subjected to various evaluations as in Examples 1a and 1b. The results were as shown in Table 3.

### Example 12

Raw materials that give the alloy composition of CuBe165 (JIS C1700) shown in Table 2 were used and subjected to the same process as in Examples 1a and 1b to obtain a solution-annealed cold-worked material. The solution-annealed cold-worked material was then subjected to aging treatment at 410° C. for 6 hours to obtain an overaged material. The material thus obtained was subjected to various evaluations as in Examples 1a and 1b. The results were as shown in Table 3.

### Example 13

Raw materials that give the alloy composition of CuBe165 (JIS C1700) shown in Table 2 were used and subjected to the same process as in Examples 1a and 1b to obtain a solution-annealed cold-worked material. The solution-annealed cold-worked material was then subjected to aging treatment at 430° C. for 9 hours to obtain an overaged material. The material thus obtained was subjected to various evaluations as in Examples 1a and 1b. The results were as shown in Table 3.

### Example 14

Raw materials were weighed to give the alloy composition of CuBe11 (JIS C1751) shown in Table 2, melted and cast to produce an ingot of the CuBe11 alloy. This ingot was subjected to the same process as in Examples 1a and 1b to obtain a forged ingot. This forged ingot was water-cooled from 850° C. to be solution-annealed, and then subjected to 40% cold working to obtain a solution-annealed cold-worked material. The resulting material was subjected to various evaluations as in Examples 1a and 1b. The results were as shown in Table 3.

### Examples 15a to 15c (Comparative)

For comparison, Table 3 shows, as data for chromium molybdenum steel (SCM435), the values set forth in FIG. 2(b) and Table 1 of Non-Patent Literature 1 (Hisao Matsunaga, Junichiro Yamabe, and Saburo Matsuoka, “Proposal of Design Method Enabling Cr-Mo Steels to be Used in High-Pressure Hydrogen Gas Environment”, Journal of the Surface Science Society of Japan Vol. 36, No. 11, pp. 562-567, 2015), and in Table 5 and FIG. 5 of Non-Patent Literature 2 (Saburo Matsuoka, Hisao Matsunaga, Junichiro Yamabe, Shigeru Hamada, and Takashi lijima, “Various strength properties of SCM435 and SNCM439 low-alloy steels in 115 MPa hydrogen gas and proposal of design guideline”, Transactions of the JSME, Vol. 83, No. 854, pp. 1-20, 2017 [DOI:10.1299/transjsme.17-00264] ).

### Example 16 (Comparative)

For comparison, Table 3 shows, as data for nickel-chromium-molybdenum steel (SNCM439), the values set forth in Table 5 and FIG. 5 of Non-Patent Literature 2.

TABLE 2

| | Alloy type and | Relevant | Alloy composition (% by mass) | | | | | | |
|---|---|---|---|---|---|---|---|---|---|
| | temper | standard | Be | Co | Ni | Fe | Ni + Co | Ni + Co + Fe | Cu + Be + Ni + Co + Fe |
| Ex. 1a* | CuBe25-AT | JIS C1720 | 1.87 | 0.23 | — | — | 0.23 | 0.23 | 99.5 or more |
| Ex. 1b* | CuBe25-AT | | 1.87 | 0.23 | — | — | 0.23 | 0.23 | 99.5 or more |
| Ex. 2* | CuBe25-F XHM | | 1.87 | 0.23 | — | — | 0.23 | 0.23 | 99.5 or more |
| Ex. 3 | CuBe25-F HM | | 1.87 | 0.23 | — | — | 0.23 | 0.23 | 99.5 or more |
| Ex. 4 | CuBe25-F 1/2HM | | 1.87 | 0.23 | — | — | 0.23 | 0.23 | 99.5 or more |
| Ex. 5 | CuBe25-F 3/8HM | | 1.87 | 0.23 | — | — | 0.23 | 0.23 | 99.5 or more |
| Ex. 6 | CuBe25-F 1/4HM | | 1.87 | 0.23 | — | — | 0.23 | 0.23 | 99.5 or more |
| Ex. 7 | CuBe25-F OHM | | 1.87 | 0.23 | — | — | 0.23 | 0.23 | 99.5 or more |
| Ex. 8* | CuBe165-AT | JIS C1700 | 1.69 | 0.23 | — | — | 0.23 | 0.23 | 99.5 or more |
| Ex. 9 | CuBe165-F HM | | 1.69 | 0.23 | — | — | 0.23 | 0.23 | 99.5 or more |
| Ex. 10 | CuBe165-F 1/2HM | | 1.69 | 0.23 | — | — | 0.23 | 0.23 | 99.5 or more |
| Ex. 11 | CuBe165-F 3/8HM | | 1.69 | 0.23 | — | — | 0.23 | 0.23 | 99.5 or more |
| Ex. 12 | CuBe165-F 1/4HM | | 1.69 | 0.23 | — | — | 0.23 | 0.23 | 99.5 or more |
| Ex. 13 | CuBe165-F OHM | | 1.69 | 0.23 | — | — | 0.23 | 0.23 | 99.5 or more |
| Ex. 14 | CuBe11-AT | JIS C1751 | 0.39 | — | 1.91 | — | 1.91 | 1.91 | 99.5 or more |

| | | | |
|---|---|---|---|
| Ex. 15a* | SCM435 | JIS SCM435 | Chromium molybdenum steel (standard values: C: 0.33-0.38, |
| Ex. 15b* | SCM435 | | Si: 0.15-0.35, Mn: 0.60-0.90, P: 0.030 or less, S: 0.030 or |
| Ex. 15c* | SCM435 | | less, Ni: 0.25 or less, Cr: 0.90-1.20, Mo: 0.15-0.30, and the balance: Fe) |
| Ex. 16* | SNCM439 | JIS SCM439 | Nickel-chromium-molybdenum steel (standard values: |
| | | | C: 0.36-0.43, Si: 0.15-0.35, Mn: 0.60-0.90, P: 0.030 or less, S: 0.030 or |
| | | | less, Ni: 1.60-2.00, Cr: 0.60-1.00, Mo: 0.15-0.30, and the balance: Fe) |

*indicates a comparative example.

TABLE 3

| | | Slow strain rate tensile test (SSRT) | | | | | | | | |
|---|---|---|---|---|---|---|---|---|---|---|
| | | | | | 0.2% | | | Charpy | Fracture | |
| | | | Tensile | 0.2% | yield | | | impact test | toughness test | |
| | | Tensile | strength in | yield | strength | Relative | | Charpy | K_{IC} | K_{IC} |
| | | strength | 115 MPa | strength | in 115 | reduction | Vickers | impact test | in air | in H₂^{※} |
| | Alloy type | in air | H₂ | in air | MPa H₂ | of area | hardness | in air | (MPa · | (MPa · |
| | and temper | (MPa) | (MPa) | (MPa) | (MPa) | (RRA) | (HV) | (J/cm²) | m^{-1/2}) | m^{-1/2}) |
| Ex. 1a* | CuBe25-AT | 1231 | — | — | — | — | 377 | 8 | 36 | — |
| Ex. 1b* | CuBe25-AT | 1232 | 1266 | — | — | 1.05 | 377 | — | 30 | 32 |
| Ex. 2* | CuBe25-F XHM | 1100 | — | — | — | — | 337 | 25 | — | — |
| Ex. 3 | CuBe25-F HM | 973 | 975 | 875 | 890 | 1.06 | 306 | 30 | 60.8 | — |
| Ex. 4 | CuBe25-F 1/2HM | 882 | — | 690 | — | — | 282 | 44 | 77.2 | — |
| Ex. 5 | CuBe25-F 3/8HM | 850 | 873 | 735 | 760 | 1.02 | 273 | 45 | 72.3 | 86.5 |
| Ex. 6 | CuBe25-F 1/4HM | 837 | — | 635 | — | — | 250 | 54 | 86.1 | — |
| Ex. 7 | CuBe25-F OHM | 759 | — | 550 | — | — | 240 | 62 | 78.8 | — |
| Ex. 8* | CuBe165-AT | 1200 | — | 1007 | — | — | 376 | 10 | — | — |
| Ex. 9 | CuBe165-F HM | 991 | — | 812 | — | — | 303 | 41 | — | — |
| Ex. 10 | CuBe165-F 1/2HM | 960 | — | 787 | — | — | 288 | 50 | — | — |
| Ex. 11 | CuBe165-F 3/8HM | 862 | — | 701 | — | — | 275 | 63 | — | — |
| Ex. 12 | CuBe165-F 1/4HM | 822 | — | 639 | — | — | 257 | 70 | — | — |
| Ex. 13 | CuBe165-F OHM | 736 | — | 602 | — | — | 225 | 78 | — | — |
| Ex. 14 | CuBe11-AT | 724 | 734 | 603 | 608 | 1.01 | 220 | 90 | — | — |
| Ex. 15a* | SCM435 | — | — | — | — | — | — | — | 236^{#1} | 160^{#1} |
| Ex. 15b* | SCM435 | 843^{#1} | 820^{#1} | — | — | 0.64^{#1} | — | — | 205^{#1} | 64^{#1} |
| Ex. 15c* | SCM435 | 838^{#2} | — | 681^{#2} | — | 0.35-0.72^{#2} | — | — | 216.3^{#2} | 57^{#2} |
| Ex. 16* | SNCM439 | 867^{#2} | — | 738^{#2} | — | 0.36-0.80^{#2} | — | — | 226.8^{#2} | 57.2^{#2} |

*indicates a comparative example.
^{※}The pressure of H₂ in the fracture toughness test is 115 MPa in Examples 1a to 14, 15c and 16, and 45 MPa in Examples 15a and 15b.
^{#1}The values in Examples 15a and 15b are those set forth in FIG. 2(b) and Table 1 of Non-Patent Literature 1.
^{#2}The values in Examples 15c and 16 are those set forth in Table 5 and FIG. 5 of Non-Patent Literature 2.

Supplementary description of the evaluation items shown in Table 3 is provided below.

With respect to the evaluation of the fracture toughness test, when the measured value under hydrogen is lower than the measured value in air by 20% or more, it may be determined that deterioration under hydrogen occurred. In some cases, the measured value under hydrogen may exceed the measured value in air; however, in principle, the properties are not improved under hydrogen, and therefore, the measured value is due to a variation in the measurement, and it is determined that there is no change in the hydrogen properties.

The relative reduction of area RRA is defined as the ratio RA_{H2}/RA_{Air}, wherein RA_{H2} represents the reduction of area (% area reduction of the broken portion at break) of the test material under hydrogen, and RA_{Air} represents the reduction of area (% area reduction of the broken portion at break) of the test material in air. When the RRA is 0.8 or less, it is determined that the material is not usable under hydrogen because it undergoes deterioration in hydrogen. A measured value may sometimes exceed 1.0; however, this is due to a variation in the test, and not because the properties were improved under hydrogen, and it is determined that hydrogen deterioration did not occur.

What is claimed is:

1. A hydrogen-resistant material for being processed into a hydrogen-resistant structural part used by being operated in a hydrogen atmosphere, the hydrogen-resistant material being composed of a beryllium copper alloy comprising:
0.20 to 2.70% by mass of Be;
0.20 to 2.50% by mass in total of at least one selected from the group consisting of Co, Ni, and Fe;
the balance consisting of Cu and unavoidable impurities, wherein a total content of Cu, Be, Co, Ni, and Fe is 99.0% by mass of more of the beryllium copper alloy,
wherein the hydrogen-resistant material exhibits a tensile strength of 700 MPa or more, according to a slow strain rate tensile test performed at a strain rate of 5×10⁻⁵ s⁻¹ or less, in each of an air atmosphere and a hydrogen atmosphere at 115 MPa,
wherein the hydrogen-resistant material exhibits a relative reduction of area (RRA) of 0.80 or more, as determined by the slow strain rate tensile test, and
wherein the hydrogen-resistant material exhibits a fracture toughness value K_{IC} of 50 MPa·m^{1/2} or more, in each of an air atmosphere and a hydrogen atmosphere at 115 MPa.

2. The hydrogen-resistant material according to claim 1,
wherein in the beryllium copper alloy,
a Be content is 1.60 to 2.70% by mass,
a total content of Co and Ni is 0.20% by mass or more,
a total content of Cu, Ni, and Fe is 0.60% by mass or less, and
a total content of Cu, Be, Co, Ni and Fe is 99.5% by mass or more.

3. The hydrogen-resistant material according to claim 1, wherein the hydrogen-resistant material exhibits a Charpy impact value of 21 J/cm² or more, as measured by a V-notch Charpy impact test in an air atmosphere.

4. The hydrogen-resistant material according to claim 3, wherein the Charpy impact value is 30 J/cm² or more.

5. The hydrogen-resistant material according to claim 1, wherein the hydrogen-resistant material exhibits a 0.2% yield strength of 520 MPa or more, in each of an air atmosphere and a hydrogen atmosphere at 115 MPa.

6. A hydrogen-resistant structural part produced using the hydrogen-resistant material according to claim 1.

7. The hydrogen-resistant structural part according to claim 6, wherein the hydrogen-resistant structural part is at least one selected from the group consisting of a container, a pipe, a valve, and a joint, which are brought into direct contact with high-pressure hydrogen, and a constituent member of a hydrogen compressor.

8. The hydrogen-resistant structural part according to claim 7, wherein the hydrogen-resistant structural part is the constituent member of the hydrogen compressor, and the constituent member of the hydrogen compressor is at least one selected from the group consisting of a piston and a cylinder of a reciprocating compressor, a rotor and a casing of a rotary compressor, an impeller of an axial compressor, and an impeller and a shaft of a centrifugal compressor.
